(19) United States
(12) Patent Application Publication
(10) Pub. No.: US 2011/0268443 A1
(43) Pub. Date: Nov. 3, 2011

(54) INTERFACE FOR PLUGGABLE PON ONT

(75) Inventor: Gal Adler, Tel Aviv (IL)

(73) Assignee: PMC Sierra Ltd., Herzliya Pituach (IL)

(21) Appl. No.: 13/096,044

(22) Filed: Apr. 28, 2011

Related U.S. Application Data
(60) Provisional application No. 61/329,124, filed on Apr. 29, 2010.
(60) Provisional application No. 61/347,425, filed on May 23, 2010.

(51) Int. Cl. H04J 14/00

(52) U.S. Cl. 398/58

(57) ABSTRACT

An interface between an SFP compliant host device and an SFP PON ONT pluggable module is disclosed. The disclosed interface specification enables implementation of an SFP MSA (INF-8074i) compliant port which can host a PON ONT in a SFP module form factor, while maintaining full backwards compatibility with legacy SFP MSA compliant transceivers. Therefore, a host implemented according to this specification would be compatible with both the SFP PON ONT and any standard SFP MSA transceiver.

### CROSS-REFERENCE TO RELATED APPLICATIONS

This application claims the benefit of provisional patent application (PPA) Ser. No. 61/329,124 filed Apr. 29, 2010 and Ser. No. 61/347,425 filed May 23, 2010 by the present inventors, which is incorporated by reference.

### FIELD OF THE INVENTION

The present embodiment generally relates to the field of communications, and in particular, it concerns an interface between an SFP compliant host device and an SFP PON ONT pluggable module.

### BACKGROUND OF THE INVENTION

The small form-factor pluggable (SFP) (also known as mini-GBIC) is a widely used telecommunications (telecom) industry standard developed by the SFF group. SFP can be used for pluggable transceiver modules and is most commonly used for optical transceivers. An SFP port enables telecom and networking products, such as routers, switches, and gateways, to connect a wide range of transceivers, which are readily available from multiple vendors. Currently available SFP transceivers include support for SONET, gigabit Ethernet, fibre channel, and other communications standards.

The SFP transceiver is specified by a multi-source agreement (MSA) between competing manufacturers. The SFP (and the similar SFP+) modules are defined by SFF group documents:

INF 8074i—Specification for SFP (Small Form-factor Pluggable) Transceiver,

SFF 8431—Specification for Enhanced Small Form Factor Pluggable Module, “SFP+”

The SFF group documents define the mechanical and electrical interface specifications of the host connector and the pluggable module connector. A pluggable module is also referred to in this document as an SFP module. An SFP module connector mates with a host connector, this connection being referred to as an SFP port. The term SFP port refers to the mechanical and electrical interface for the host and module, and is specified by the SFP interface specification. The SFP interface specification is also referred to as the SFP interface standard and SFP MSA standard. The SFP port includes SFP compatible interface pins for both the host and SFP module. The single term SFP port is used to refer to the port on either the host or SFP module, the context of which will be obvious to one skilled in the art. Where differentiation is necessary between an SFP port on a host and an SFP port on a module, the terms SFP host port and the SFP module port are respectively used.

As passive optical networks (PON), such as gigabit passive optical networks (GPONs) and Ethernet passive optical networks (EPONs) become popular, there is an increasing demand to implement a PON optical network terminal (ONT) (also referred to as an optical network unit, ONU) in an SFP compliant form factor. In other words, to develop a PON ONT that could plug into an SFP port of a host device, thereby enabling the host device to connect to a PON network.

However, PON ONT devices are more than transceivers, as ONTs also include MAC layer, data processing, and management and control functions. The SFP interface as currently defined is missing important features that are needed in order to support a PON ONT.

There is therefore a need for an SFP compliant interface that allows a host device to communicate alternatively with either conventional SFP modules or an SFP PON ONT pluggable module.

### SUMMARY

According to the teachings of the present embodiment there is provided a system including: a small form-factor pluggable (SFP) port in a host; an interface controller in the host, the interface controller operational to control the SFP port, the interface controller including: an SFP module interface implemented using the SFP port; and an SFP passive optical network (PON) optical networking terminal (ONT) module interface implemented using the SFP port.

In an optional embodiment, the SFP PON ONT module is a gigabit passive optical network (GPON) ONT module. In another optional embodiment, the SFP PON ONT module is an Ethernet passive optical network (EPON) ONT module.

According to the teachings of the present embodiment there is provided a method of initializing an interface in a host, wherein the interface includes a small form-factor pluggable (SFP) host port the method including the host: detecting operational connection of a module having an SFP module port to the interface; identifying a module type of the module, the module type selected from the group consisting of: PON and SFP; and initializing the interface for communication between the host and the module based on the module type.

In an optional embodiment, the step of identifying includes identifying a module type of gigabit passive optical network (GPON). In another optional embodiment, the step of identifying includes identifying a module type of Ethernet passive optical network (EPON).

In an optional embodiment, the module type is identified as SFP and the step of initializing includes initializing the interface for communications using SFP interface specification. In another optional embodiment, the module type is identified as PON and the step of initializing includes initializing the interface for communications using a modified SFP interface specification. In another optional embodiment, when the module type is identified as PON the step of configuring includes the host performing a module initialization sequence. In another optional embodiment, the when the module type is identified as PON the step of configuring includes the host performing a module configuration.

According to the teachings of the present embodiment there is provided a system including: an interface in a host, the interface including a small form-factor pluggable (SFP) port; and a module having an SFP port; wherein the host is configured to: detect operational connection of the module to the interface; identify a module type of the module, the module type selected from the group consisting of: PON and SFP; and initialize the interface for communication between the host and the module based on the module type.

In an optional embodiment, the host is configured to identify a module type of gigabit passive optical network (GPON). In another optional embodiment, the host is configured to identify a module type of Ethernet passive optical network (EPON).

In an optional embodiment, the module is a SFP passive optical network (PON) optical network terminal (ONT) module having ONT functionality and using the SFP port to communicate with the host.

According to the teachings of the present embodiment there is provided a system including: an SFP port; and an SFP module having ONT functionality and using the SFP port to communicate with a host using a modified SFP interface specification.

In an optional embodiment, the SFP module includes gigabit passive optical network (GPON) functionality. In another optional embodiment, the SFP module includes Ethernet passive optical network (EPON) functionality.

### BRIEF DESCRIPTION OF FIGURES

The embodiment is herein described, by way of example only, with reference to the accompanying drawings, wherein:

FIG. 1 is a diagram of the current SFP interface standard hardware interface.

FIG. 2 is a diagram of an example implementation of a host board interface circuit.

FIG. 3 is a table of the current SFP interface standard EEPROM memory map.

FIG. 4 is a table of the modified interface.

FIG. 5 is a table of supported PON device commands.

FIG. 6 is a diagram of a system for a host interfacing alternatively between a conventional SFP module and a PON SFP ONT pluggable module.

FIG. 7 is a flowchart of a method of initialization.

### DETAILED DESCRIPTION

The principles and operation of the system according to a present embodiment may be better understood with reference to the drawings and the accompanying description. A present embodiment is a system for interfacing between an SFP compliant host device and an SFP PON ONT pluggable module. The system facilitates a host device communicating alternatively with either conventional SFP modules or an SFP PON ONT pluggable module.

The system includes an interface controller operational to control a small form-factor pluggable (SFP) compatible port, the interface controller having at least a first configuration implementing an SFP interface using the SFP compatible port and at least a second configuration implementing a passive optical network (PON) SFP optical networking terminal (ONT) module interface using the SFP compatible port. The PON SFP ONT module interface uses a modified interface, as described below. Also described is a method of initializing an interface in a host wherein the interface includes a set of small form-factor pluggable (SFP) compatible interface pins. The method of initializing includes the host detecting operational connection of a module having an SFP port to the interface; identifying a module type of the module, the module type including PON and SFP; and configuring the interface for communication between the host and the module based on the module type.

The conventional SFP interface as currently defined in the SFP specifications is sufficient for controlling SFP modules such as transceivers. Transceivers can be described as “dumb” devices, requiring a relatively simple interface specification for operation. In contrast, ONT devices require a more complex and flexible interface including increased management and control functions. The SFP interface as currently defined is lacking features that are needed in order to support a PON ONT. The present embodiment defines a modified SFP interface specification (also referred to as the “modified interface”) which enables features sufficient for controlling an PON ONT (implemented as a pluggable SFP module, and referred to as an SFP PON ONT module) while also maintaining full backwards compatibility to the original SFP interface standard. The modified interface is also referred to as a SFP PON ONT module interface. SFP ports implemented according to the current embodiment can support both pluggable SFP PON ONTs, as well as conventional SFP pluggable transceivers. In the context of this document, the term “module” without further qualification generally refers to a module that can be either a conventional SFP module or a PON SFP module.

A non-limiting example of features lacking in the current SFP interface standard, that are needed for PON ONT implementation as an SFP pluggable module include:
Reset from host.
Dying gasp indication from host (an indication that power has been lost in the host)
Interrupt request to host.
Network clock output. This clock output may be required for TDM services, time/frequency synchronization protocols, and latency sensitive applications.

Additionally, the modified interface requires more flexible control and configuration, as compared to the current interface, to enable management of all the features of the ONT. Examples of features of the ONT for which management is desired include updating firmware on the ONT and managing various service provisioning parameters such as password and serial number.

This description discloses a hardware (electrical) and software interface specification, which is based on the SFP standard interface. This modified interface specification enables the support of a PON ONT/ONU pluggable SFP module, and the required feature set associated with the modified interface. Preferably, the PON ONT module is a GPON, or alternatively an EPON module.

The modified interface includes:

Pin descriptions—modification of the SFP standard (the pin descriptions of the INF-8074 standard) for support of additional and alternative features. Some signals are assigned new functionality that is required for PON application. In legacy transceiver applications (interfacing with conventional SFP modules), the modified signals revert to original functions of the pins.

Management interface—a management interface is defined, based on inband (that is, using the data path) communication protocol between the host and the SFP module.

Initialization sequence—an initialization sequence is defined, which includes a method for the host to identify the module type of the pluggable module (PON module or conventional/legacy transceiver), and in case of a PON module, take the required actions to initialize, configure and activate the PON module.

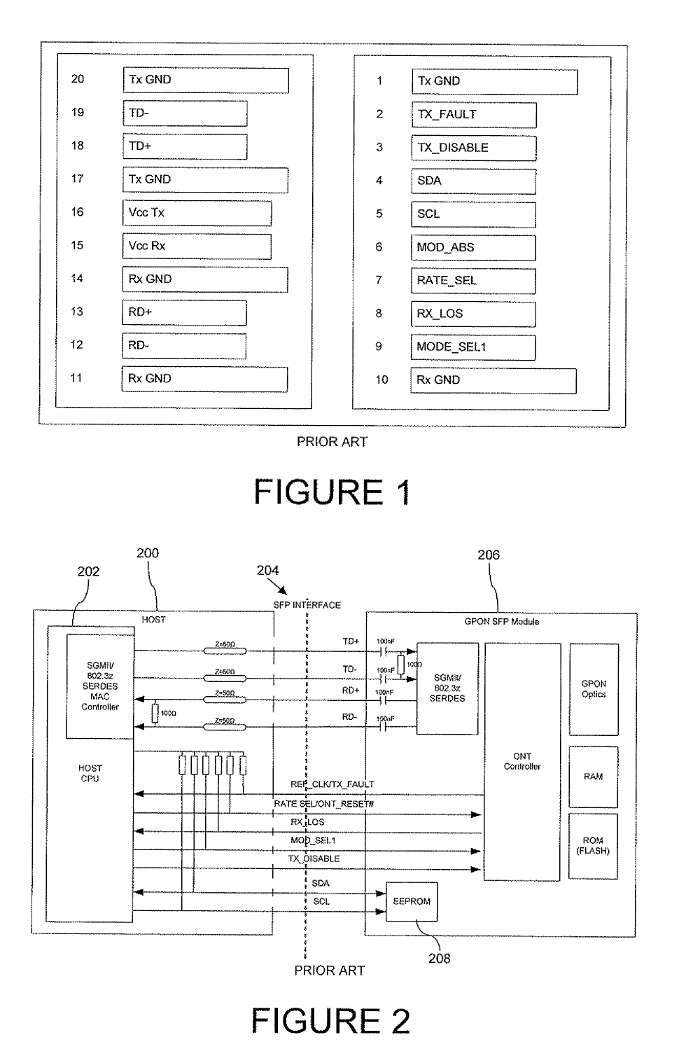

Referring now to the drawings, FIG. 1 is a diagram of the current SFP interface standard hardware interface, referred to in the context of this document as an SFP compatible set of interface pins. Refer to the specifications listing the background section for additional information on this pin layout.

Referring now to the drawings, FIG. 2 is a diagram of an example implementation of a host board interface circuit. Note that FIG. 2 is provided to assist with clarifying the current description and assisting with implementation. The choices used to assist in the description of this embodiment should not detract from the validity and utility of the invention. The host board interface circuit includes a host 200 and SFP module 206 (shown as a GPON SFP module). Host 200 includes one or more processors (shown as host CPU) 202. An SFP interface 204 connects host 200 and SFP module 206. SFP module 206 includes an EEPROM 208.

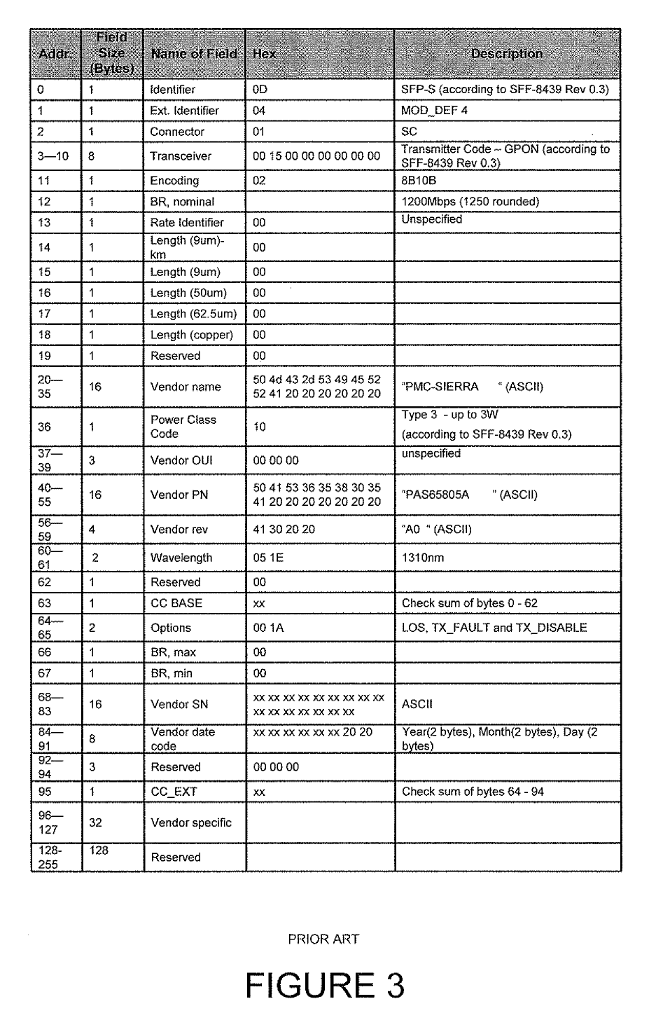

Referring now to the drawings, FIG. 3 is a table of the current SFP interface standard EEPROM memory map, also known as serial ID memory contents. The SFP MSA defines a 256-byte memory map in EEPROM describing the SFP module's capabilities, features, and/or identification information. The contents of the EEPROM memory map can be modified according to specific vendor implementations. Standard interfaces, manufacturer, and other information are accessible over a 2-wire serial interface at the 8-bit address 1010000X (A0h).

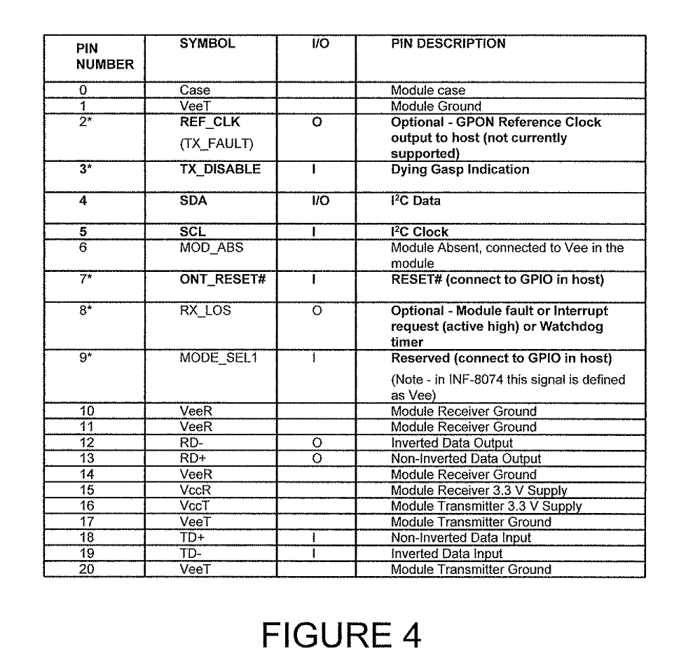

Referring now to the drawings, FIG. 4 is a table of the modified interface—the current SFP interface modified with extended or dedicated functionality to define features that are needed in order to support a PON ONT. The modified interface is defined to maintain backwards compatibility to SFP or SFP+ modules based on the INF-8074 specification. As will be described below, when a host detects that a connected module is a standard SFP module, the host uses the standard SFP signals for communications via the SFP interface with the conventional SFP module. When a host detects that a connected module is a PON SFP module, the host uses the modified interface for communications via the SFP interface with the PON SFP module.

Each line of the table corresponds to a single pin. The column PIN NUMBER corresponds to the pins and associated pin numbers in FIG. 1. An asterisk (“*”) next to a PIN NUMBER indicates that the PIN DESCRIPTION for that pin is modified from the current SFP interface to support the modified interface. The column SYMBOL is the shorthand symbol used for the pin. In the SYMBOL column, logical signals are active high unless indicated by a hash mark (“#”). The column I/O indicates whether the pin is used for input (I) or output (O), defined from the perspective of the module.

The column PIN DESCRIPTION lists the function of the pin, or more accurately, the function of the signal associated with the pin, in the modified interface, as noted by an asterisk next to the PIN NUMBER. For pins that have the same functionality in the modified interface as in the current interface (no asterisk next to the PIN NUMBER) the current interface function is listed. Signals defined as optional are not needed in all PON applications, and can be used as required by a specific application.

An exemplary implementation of the modified interface is as follows:

Pin 2, REF_CLK (TX_FAULT in the current standard) is an optional output signal from the SFP module for a PON reference clock output to the host.

Pin 3, (TX_DISABLE) is an input signal to the SFP module for a dying gasp indication.

Pin 7, ONT_RESET is an input signal, active low, to the SFP module used for resetting the module. The ONT_RESET pin should be connected to a GPIO (general-purpose input/output pin) in the host.

Pin 8, RX_LOS is an OPTIONAL output signal from the SFP module for indication of a Module fault or Interrupt request (active high) or Watchdog timer.

Pin 9, MODE_SEL1 is an input signal to the SFP module that is reserved (connected to GPIO in host) for future applications. Note, in the current SFP standard (INF-8074) this signal is defined as Vee).

The previous descriptions are one exemplar implementation. Based on this description, one skilled in the art will be able to design alternate pin descriptions. One non-limiting example of an alternative implementation is to exchange the functions of one or more of the above-described pins. However, the current description should be sufficient for implementation and adherence to the modified specification as described will facilitate compatibility among hosts, legacy SFP modules, and future PON SFP modules. A feature of the above-described set of pin functions, regardless of pin assignment, is that this set of pin functions is sufficient for implementation of the modified specification.

The PON SFP module, in this case an ONT device, or alternatively referred to as a PON device, is managed and configured through the SFP Ethernet interface. Configuration can be accomplished using the protocol defined in the following description. PON device management messages are encapsulated in Ethernet frames that are sent/received to/from, the PON device Ethernet MAC address.

Two types of messages may be sent by the host: a SET message, which is used to write device parameters, and a GET message, which is used to read the PON device parameters and status indications. The PON device (ONT device) responds to both SET and GET message with an ACK message that is used to acknowledge receipt of the SET or GET message.

The following is a non-limiting example of an Ethernet frame structure for the GET, SET, and ACK messages. ACK messages are sent from the PON device to the host in response to any SET or GET message. The data format for the ACK message is the same format as for the SET message.

SET message

| # Ethernet HEADER ----- | |
|---|---|
| 00 0c d5 00 01 00 | # Destination MAC (GPON device) |
| xx xx xx xx xx xx | # Source MAC (host) |

| | |
|---|---|
| 12 00 | # EtherType |

| # SET request ----------- | |
|---|---|
| 10 xx | # 10 indicates SET xx = Opcode |

# message data (16 bytes, 0 padded if necessary)
xx xx xx xx xx xx xx xx xx xx xx xx xx xx xx xx
# 28 bytes padding for 64 byte frame
00 00 00 00 00 00 00 00 00 00 00 00 00 00
00 00 00 00 00 00 00 00 00 00 00 00 00 00
# FCS
xx xx xx xx

GET message

| # Ethernet HEADER ----- | |
|---|---|
| 00 0c d5 00 01 00 | # Destination MAC (GPON device) |
| xx xx xx xx xx xx | # Source MAC (host) |

| | |
|---|---|
| 12 00 | # EtherType |

| # GET request ----------- | |
|---|---|
| 20 xx | # 20 indicates GET xx = Opcode |

# 44 bytes padding for 64 byte frame
00 00 00 00 00 00 00 00 00 00 00 00 00 00 00 00
00 00 00 00 00 00 00 00 00 00 00 00 00 00
00 00 00 00 00 00 00 00 00 00 00 00 00 00
# FCS
xx xx xx xx

ACK message

| # Ethernet HEADER ----- | |
|---|---|
| xx xx xx xx xx xx | # Destination MAC (host) |
| 00 0c d5 00 01 00 | # Source MAC (GPON device) |

| 40 00 | # EtherType |
|---|---|
| # ACK ----------- | |
| 30 xx | #30 indicates ACK xx = Opcode |

# message data (16 bytes, 0 padded if necessary)
xx xx xx xx xx xx xx xx xx xx xx xx xx xx xx xx
# 28 bytes padding for 64 byte frame
00 00 00 00 00 00 00 00 00 00 00 00 00 00
00 00 00 00 00 00 00 00 00 00 00 00 00 00
# FCS
xx xx xx xx

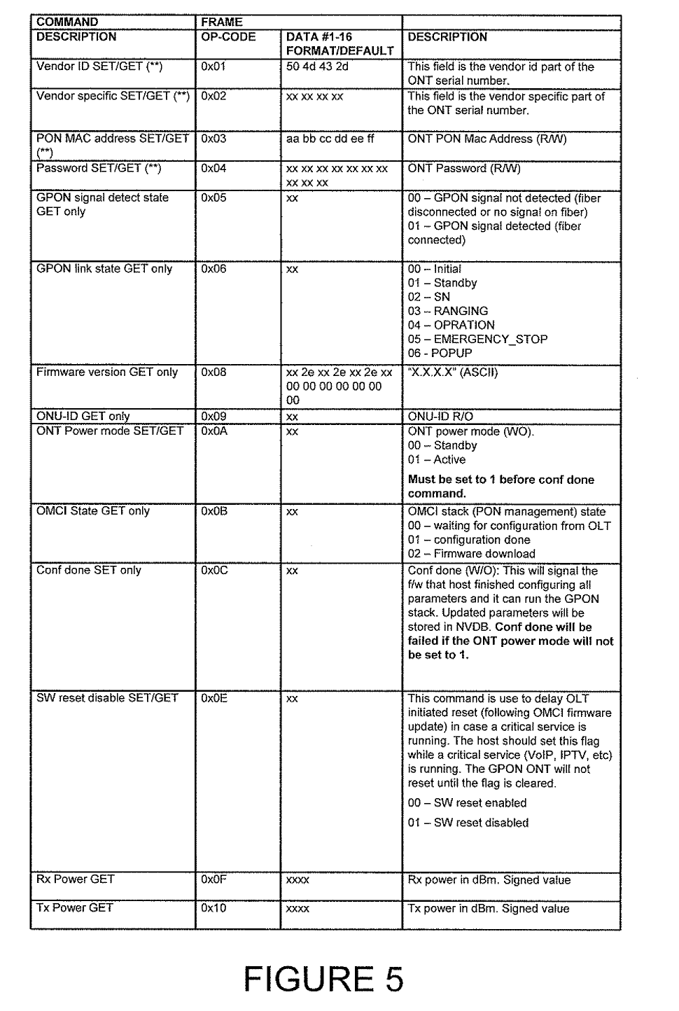

Referring now to the drawings, FIG. 5 is a table of supported PON device commands. Note, the table provides a basic set of commands that are sufficient for management of a PON module. Other commands may be added to support further features and capabilities as required. Based on this description, one skilled in the art will be able to design alternate and/or additional commands to support a specific application.

Each line on the table is one command. The COMMAND/DESCRIPTION column lists the name and/or a brief description of the command on the corresponding line. The parameters marked with a double asterisk (“**”) are preferably stored in the PON device's non-volatile-database (NVDB) when configuration of the PON device is completed (following a conf done command). The FRAME columns include an operational code (OP-CODE) which can be used as described above in reference to the GET, SET, and ACK messages, and a DATA #1-16 column listing the FORMAT of the message data and any DEFAULT values. If there are less than 16 data bytes of message data, the rest of the read/write command frame is preferably padded with zeroes. The DESCRIPTION column lists a description of the corresponding command.

An exemplary implementation of PON device commands is as follows (in the format COMMAND/DESCRIPTION, OP-CODE, FORMAT with default value(s) if any. DESCRIPTION.):

Vendor ID SET/GET (**), 0x01, 50 4d 43 2d. This field is the vendor id part of the ONT serial number.

Vendor specific SET/GET (**), 0x02, xx xx xx xx. This field is the vendor specific part of the ONT serial number.

PON MAC address SET/GET (**), 0x03, aa bb cc dd ee ff. ONT PON Mac Address (R/W).

Password SET/GET (**), 0x04, xx xx xx xx xx xx xx xx xx xx. ONT Password (R/W).

PON signal detect state GET only, 0x05, xx.
00—PON signal not detected (fiber disconnected or no signal on fiber),
01—PON signal detected (fiber connected).

PON link state GET only, 0x06, xx.
00—Initial
01—Standby
02—SN
03—RANGING
04—OPERATION
05—EMERGENCY STOP
06—POPUP

Firmware version GET only, 0x08, xx 2e xx 2e xx 2e xx 00 00 00 00 00 00 00. “X.X.X.X” (ASCII).

ONU-ID GET only, 0x09, xx. ONU-ID RIO.

ONT Power mode SET/GET, 0x0A, xx. ONT power mode (WO). Must be set to 1 before conf done command.
00—Standby
01—Active

OMCI State GET only, 0x0B, xx. OMCI stack state
00—waiting
01—configuration done
02—Firmware download

Conf done SET only, 0x0C, xx. Conf done (W/O): This will signal the firmware that the host has finished configuring all parameters and the module can run the PON stack. Updated parameters will be stored in NVDB. Conf done will fail if the ONT power mode has not been set to 1.

SW reset disable SET/GET, 0x0E, xx. This command is used to delay OLT initiated reset (following OMCI firmware update) in case a critical service is running. The host should set this flag while a critical service (VoIP, IPTV, etc) is running. The SFP PON ONT will not reset until the flag is cleared.
00—SW reset enabled
01—SW reset disabled

Rx Power GET, 0x0F, xxxx. Rx power in dBm. Signed value.

Tx Power GET, 0x10, xxxx. Tx power in dBm. Signed value.

Note that in the event of power loss in the host, the host should preferably assert the dying gasp signal (pin #3). For the PON SFP module (ONT device) to send the dying gasp physical layer operations, administration and maintenance (PLOAM) signal, the host must continue to supply power to the PON SFP module for at least 10 milliseconds (ms) following the assertion of the dying gasp signal.

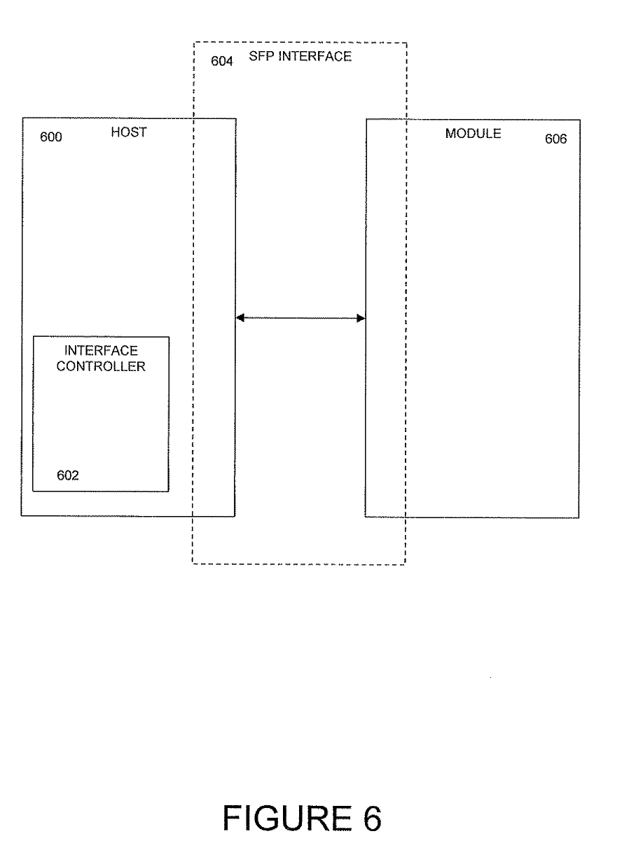

Referring to FIG. 6, a diagram of a system for a host interfacing alternatively between an a conventional SFP module or an PON SFP ONT pluggable module, a host 600 includes an interface controller 602 operational to control an SFP compatible set of interface pins (shown as SFP interface) 604. SFP interface 604 facilitates communication between the host 600 and a module 606. Referring also to FIG. 2, host 600 is comparable to host 200. Interface controller 602 can be implemented as part of host CPU 202 or be implemented as a separate component in host 600/200. SFP interface 604 is comparable to SFP interface 204. Module 606 can be a conventional SFP module or a PON SFP module such as GPON SFP module 206.

Interface controller 602 includes at least a first configuration implementing an SFP interface using the SFP port. Interface controller 602 also includes at least a second configuration implementing an SFP passive optical network (PON) optical networking terminal (ONT) module interface using the SFP port. Configuration of the interface controller can alternatively be described as a mode of operation. Hence, the interface controller has at least two modes of operation, a first mode for communicating with a conventional SFP module and a second mode for communicating with a PON ONT module. As the PON ONT module uses the SFP port, the PON ONT module is also referred to as a SFP PON module. The first and second configurations can be implemented as an SFP module interface and a SFP PON ONT module interface, using hardware, software, firmware, or a combination thereof. Typically, a software configuration would be stored in a storage module and loaded from the storage module by the interface controller to implement the desired/required module interface. In another implementation, the system can include two or more hardware circuits, each of the two circuits used to implement the SFP module interface or the SFP PON ONT module interface, as appropriate. In another implementation, a single programmable logic circuit can be reconfigured to implement the desired/required module interface.

A SFP PON ONT module includes an SFP port. The SFP PON ONT module has ONT functionality, and uses the SFP port to communicate with a host using the modified SFP interface specification.

In a preferred implementation, the SFP PON ONT module is a gigabit passive optical network (GPON) ONT module. In another implementation, the SFP PON ONT module is an Ethernet passive optical network PON (EPON) module.

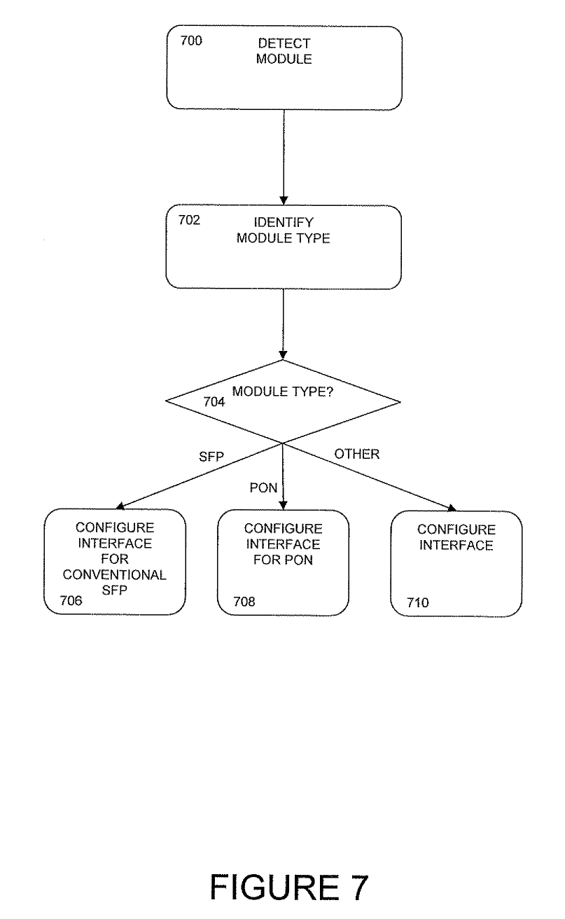

Referring to FIG. 7, a flowchart of a method of initialization, an initialization sequence is now described that can be used by a host when the host detects an SFP module. The module type is determined by the host, then the host communicates with the SFP module either using the SFP standard interface or modified interface. Note that a single SFP port is used for operational connection of an SFP module to a host, and communication between the host and SFP module is via this single SFP port. In this context, reference to communicating via either the SFP standard interface or modified interface refers to the management interface and communication protocol between the host and the SFP module, as described above. In the context of this document, the term “interface” generally refers to the combination of the SFP port (hardware) and communications protocol used by the host and SFP module to communicate via the SFP port. The initialization sequence can be used for both hot and cold plug of the pluggable modules.

A method of initializing an interface in a host includes the host detecting 700 operational connection, of a module having An SFP port, to the interface. A preferred method of detection includes the host sampling a MOD_ABS pin of the SFP port. Note that when referring to sampling a pin or communicating via a pin, a single SFP port is being used, so reference is to a common pin for either the host or module.

The host then identifies 702 a module type of the connected module. The module type includes, but is not limited to, PON SFP module (PON) or conventional/legacy SFP (SFP). A preferred method of identification includes the host reading a module transmitter code from the module. Refer back to the description in reference to FIG. 3, for module transmitter code information from the EEPROM table. A non-limiting example from the exemplar EEPROM table is address 3-10, field name “transceiver” for GPON is module transmitter code “00 15 00 00 00 00 00 00”).

The host then configures the interface for communication between the host and the module based on the module type 704. If the module type has been identified as a conventional SFP module 706, the host configures the interface for communication via the standard SFP interface.

If the module type has been identified as PON 708, the host configures the interface for communication via the modified interface. The step of configuring the modified interface preferably includes the host performing a module initialization sequence. A module initialization sequence includes a hardware (“hard”) reset (using pin 7). Optionally, the step of configuring includes the host performing a module configuration. Module configuration includes using the PON device commands, as described above in reference to FIG. 5. After module configuration, the NVDB should preferably be updated.

The end of interface configuration is indicated by sending the “conf done” command from the host to the PON SFP module. After receiving the “conf done” command, the PON stack will be activated and the ONT will attempt to connect to the associated OLT. The status of PON link can be sampled using the PON signal detect read and the PON link state read commands. Following successful activation, the PON link state will reach OPERATION state (depending on the OLT discovery cycle, the activation process can last up to a minute). If the ONT failed to reach OPERATION state, this may be due to a wrong password. Following successful activation, the OLT will start the OMCI provisioning process. OMCI provisioning status can be checked using the OMCI state read command. Once OMCI provisioning has completed successfully, user services will be available.

Note that this method also supports identifying other module types 710. Based on this description, one skilled in the art will be able to implement an appropriate host handling of other module types.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

It will be appreciated that the above descriptions are intended only to serve as examples, and that many other embodiments are possible within the scope of the present invention as defined in the appended claims.

What is claimed is:

1. A system comprising:
(a) a small form-factor pluggable (SFP) port in a host; and
(b) an interface controller in said host, said interface controller operational to control said SFP port, said interface controller including:
(i) an SFP module interface implemented using said SFP port; and
(ii) an SFP passive optical network (PON) optical networking terminal (ONT) module interface implemented using said SFP port.

2. The system of claim 1 wherein said SFP PON ONT module is a gigabit passive optical network (GPON) ONT module.

3. The system of claim 1 wherein said SFP PON ONT module is an Ethernet passive optical network (EPON) ONT module.

4. A method of initializing an interface in a host, wherein the interface includes a small form-factor pluggable (SFP) host port, the method comprising the host:
(a) detecting operational connection of a module having an SFP module port to the interface;
(b) identifying a module type of said module, said module type selected from the group consisting of: PON and SFP; and
(c) initializing the interface for communication between the host and said module based on said module type and via the host port and the SFP module port.

5. The method of claim 4 wherein the step of identifying includes identifying a module type of gigabit passive optical network (GPON).

6. The method of claim 4 wherein the step of identifying includes identifying a module type of Ethernet passive optical network (EPON).

7. The method of claim 4 wherein said module type is identified as SFP and the step of initializing includes initializing the interface for communications using SFP interface specification.

8. The method of claim 4 wherein said module type is identified as PON and the step of initializing includes initializing the interface for communications using a modified SFP interface specification.

9. The method of claim 4 wherein when said module type is identified as PON the step of configuring includes the host performing a module initialization sequence.

10. The method of claim 4 wherein when said module type is identified as PON the step of configuring includes the host performing a module configuration.

11. A system comprising:
(a) an interface in a host, said interface including a small form-factor pluggable (SFP) port; and
(b) a module having an SFP port;
wherein said host is configured to:
(i) detect operational connection of said module to said interface;
(ii) identify a module type of said module, said module type selected from the group consisting of: PON and SFP; and
(iii) initialize said interface for communication between the host and said module based on said module type.

12. The system of claim 11 wherein said host is configured to identify a module type of gigabit passive optical network (GPON).

13. The system of claim 11 wherein said host is configured to identify a module type of Ethernet passive optical network (EPON).

14. The system of claim 11 wherein said module is a SFP passive optical network (PON) optical network terminal (ONT) module having ONT functionality and using said SFP port to communicate with said host.

15. A system comprising:
(a) an SFP port; and
(b) an SFP module having ONT functionality and using said SFP port to communicate with a host using a modified SFP interface specification.

16. The system of claim 15 wherein said SFP module includes gigabit passive optical network (GPON) functionality.

17. The system of claim 15 wherein said SFP module includes Ethernet passive optical network (EPON) functionality.
